(19) United States
(12) Patent Application Publication
(10) Pub. No.: US 2022/0215311 A1
(43) Pub. Date: Jul. 7, 2022

(54) SYSTEM AND METHOD FOR MANAGING AND ADMINISTERING ARTISTIC PERFORMANCES

(71) Applicant: Beaty Capital Group, Rogers, AR (US)

(72) Inventor: Lance A. Beaty, Rogers, AR (US)

(21) Appl. No.: 17/570,256

(22) Filed: Jan. 6, 2022

Related U.S. Application Data
(60) Provisional application No. 63/134,485, filed on Jan. 6, 2021.

(51) Int. Cl. G06Q 10/06; G06F 16/28; G06F 16/242; G06Q 50/00

(52) U.S. Cl. CPC G06Q 10/06311; G06Q 50/01; G06F 16/2423; G06F 16/284

(57) ABSTRACT

A system and method for managing and administering artistic performances is provided. A management platform is included along with a method of facilitating the interaction between performers and venue operators to administer and execute performances. The system includes a user interface which links one or more user, such as a performer, venue operator, a customer, or a ticket seller. Each user enters relevant data regarding the user's preferences and the system utilizes intelligent data collection and processing to generate predictive models of user and audience behavior to optimize user interactions and facilitate optimized performance scheduling.

### CROSS-REFERENCE TO RELATED APPLICATIONS

This application claims priority pursuant to 35 U.S.C. 119(e) to U.S. Provisional Patent Application Ser. No. 63/134,485, filed Jan. 6, 2021, the entire disclosure of which is incorporated herein by reference.

### FIELD OF THE INVENTION

The invention relates generally to the planning, administering, and execution of performing arts performance, including coordinating customers, venue operators, performers/artists, and variable workforce workers.

### BACKGROUND

The planning, administration and management, and execution of live performances is a discontinuous process involving many players and contractual relationships. These players, which include artists/performers, managers, venue operators, ticket seller, and customers interact in a complex manner to place customers in the audience, performers on the stage, while ensuring that contracts are executed and managed and transactions.

Given the siloed nature of the myriad transactions necessary to effectuate a successful performance, customers, performers, and venue operators often lack the flexibility and transparency to interact at a meaningful level in the management and administration of the performance process. This lack of meaningful participation leaves many venue operators, performers, and customers with a sub-optimal, low value, and low profit experience.

To address this problem, the applicant has developed a subscription based, integrated and interactive performing arts management platform to enable the seamless and transparent interaction between venue operators and performers, as well as customers.

### SUMMARY

The present invention comprises a performing arts management platform (i.e., “the system”) and a method for facilitating the interaction between performers and venue operators to administer and execute performances (i.e., “the method”).

In one aspect, the invention provides an electronic performing arts management system for use by a user to manage performances. Here, a user includes a performer and a venue operator. In some embodiments, a user includes a performer, a venue operator, a customer (e.g., someone who visits a venue to watch a performance), and optionally, a ticket seller (e.g., third party jobber).

In one embodiment, the system includes a user interface, a database management system, data resources, and a performance venue. Here, the user interface provides a port for the user to input information and receive information related to a performance. In some embodiments, the user interface is a computer, tablet, smart phone, or the like. Here also, the performance venue can be any venue, such as, e.g., a virtual performance venue (on-line or streaming), concert hall, civic center, stadium, theater, amphitheater, or the like.

In some embodiments, the database management system includes a database, a database engine, a software program (software applications), and a data collection robot. In one embodiment, the database includes a data pool, which can store data in both sequential and non-sequential formats. Here, data is collected and organized in systems from public and proprietary resources. The software applications interact with the user through graphic and menu interfaces, other applications, and the database itself to capture and analyze data. In some embodiments, the system permits applications to define, access, and update data, such as, e.g., through a Data Definition Language (DDL) and Data Manipulation Language (DML) combined into a declarative query language of a Structured Query Language (SQL). SQL is the ANSI standard for accessing and manipulating the information stored in relational databases. In some embodiments, the database is a relational database that stores the data in the form of tables and records as structured data that can be further processed for analysis and display.

In one embodiment, the system includes an intelligent database that contains data generated by intelligent data collection application robots using artificial intelligence (i.e., intelligent data). In some embodiments, the intelligent data occupies multiple levels (i.e., intelligence levels) within the system, such as, e.g., (1) high level data mining tools that employ artificial intelligence, which manage data quality and discover relevant patterns in the data with a process called data mining and often relies on the use of techniques; (2) a user interface that employs hypermedia in a form that uniformly manages text, images, and numeric data; and (3) the database engine that supports other two layers (i.e., smart data mining and hypermedia user interface) and merges relational database techniques with object orientation.

In some embodiments, the data resources include any one or more of (1) ticket purchase information (e.g., date, venue, performer, price, purchaser (customer) personal data, and the like), (2) venue information (e.g., capacity, performance attendance, ticket sales, food and beverage sales, pre-sales, VIP upgrade sales, meet and greet sales, and the like), and (3) media consumption information sorted by location and user personal information.

In some embodiments, the media consumption information is derived from or obtained from sources such as, e.g., (1) YouTube, Amazon Music, Apple Music, Google Play Music, Idagio, LiveXLive, Pandora, Primephonic, SiriusXM, Spotify, Tidal, and the like, (2) social media user information from Twitter, Facebook, Instagram, Whatsapp, Pinterest, and the like, (3) government data resources including, e.g., U.S. Bureau of the Census, U.S. Bureau of Labor Statistics, FedStats, Current Population Statistics, City and County Business Patterns, and the like, and (4) market radio data for stations, format, listener demographics, and the like.

Using these and other data resources, a user can query for any output, such as ticket price and availability, venue size and availability, contract terms, payment information, and the like, using the subject performing arts management platform system.

In some embodiments, the software algorithms and applications allow a virtually limitless output of conditional results based on the nature of the query made by the user and the database resources that are accessed.

In some embodiments, the performing arts management platform is a subscription system with multiple levels of data access available based on the individual needs of a particular user.

In another aspect, the invention provides an electronic method for managing and administering performances, from enabling customer ticket purchase, engagement of a venue by a performer, contract execution and management, payment processing and management, advertising, data mining, and executing performances.

In one embodiment, an intelligent database collects and processes inter alia customer, performer, and venue data, and develops a direct, accurate and predictive model of performer, venue, and audience behavior. In one embodiment, a database management system, which includes a database, a database engine, a software program, and an AI-driven data collection robot, applies relational aspects of the actual artist (i.e., performer), venue and ticket purchaser actions to the various data sources noted in the above aspect, resulting in highly accurate and detailed models that predict sales, optimize performance scheduling, venue selection, ticket and product pricing and other elements of the live performance industry.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION

A preferred embodiment of the invention, illustrative of the best mode in which the applicant has contemplated applying the principles, is set forth in the following description and is shown in the drawings and is particularly and distinctly pointed out and set forth in the appended claims.

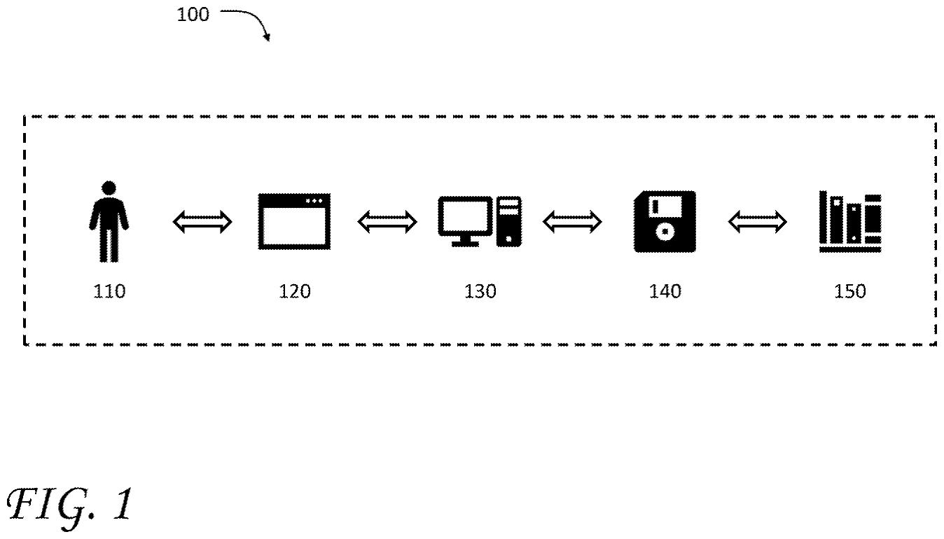

FIG. 1 is a graphical representation of a relationship between system elements of an embodiment.

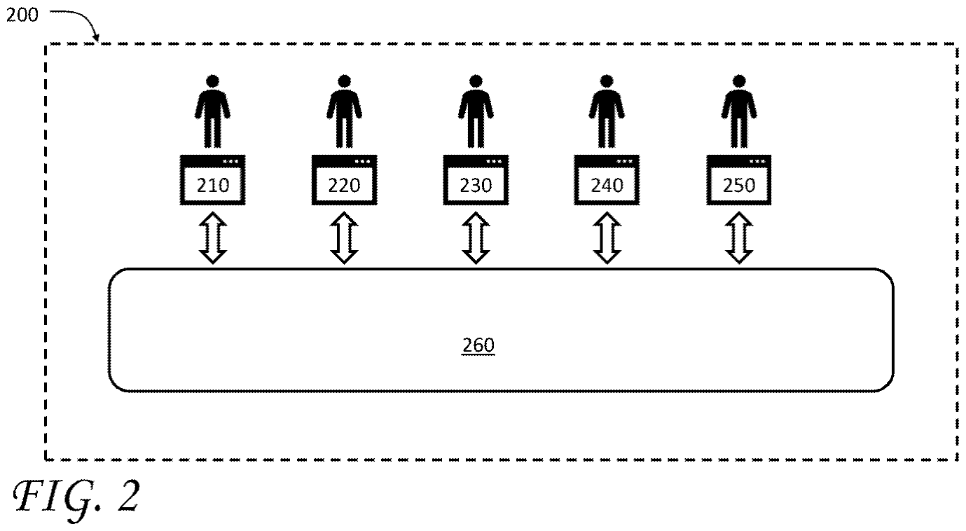

FIG. 2 is a graphical representation of a relationship between system elements of an embodiment.

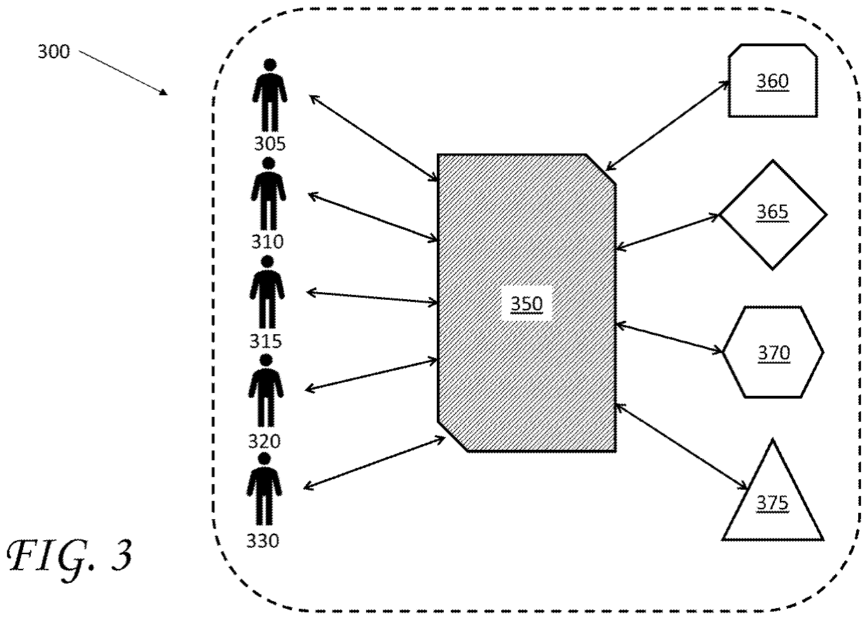

FIG. 3 is a graphical representation of a relationship between system elements of an embodiment.

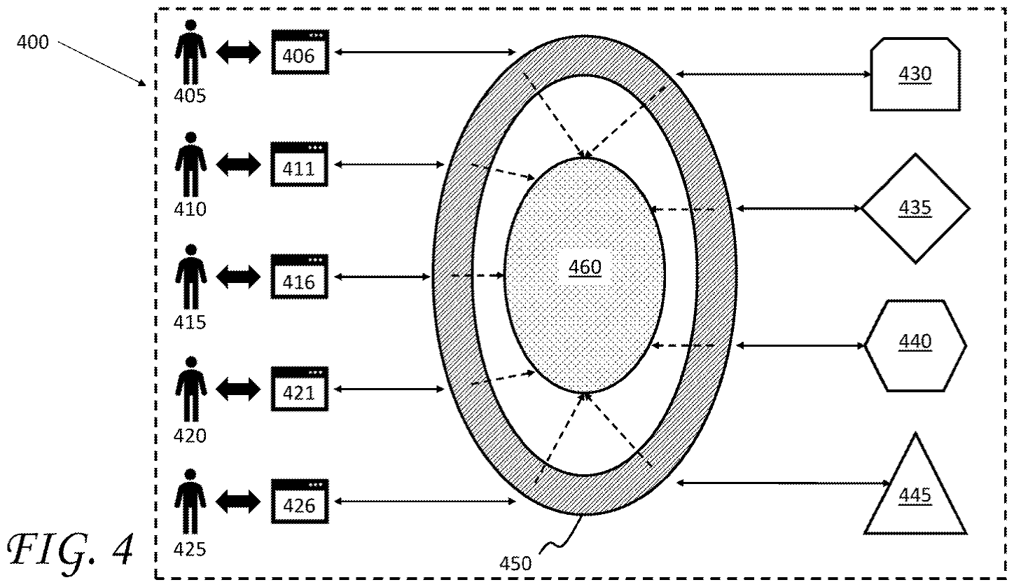

FIG. 4 is a graphical representation of a relationship between system elements of an embodiment.

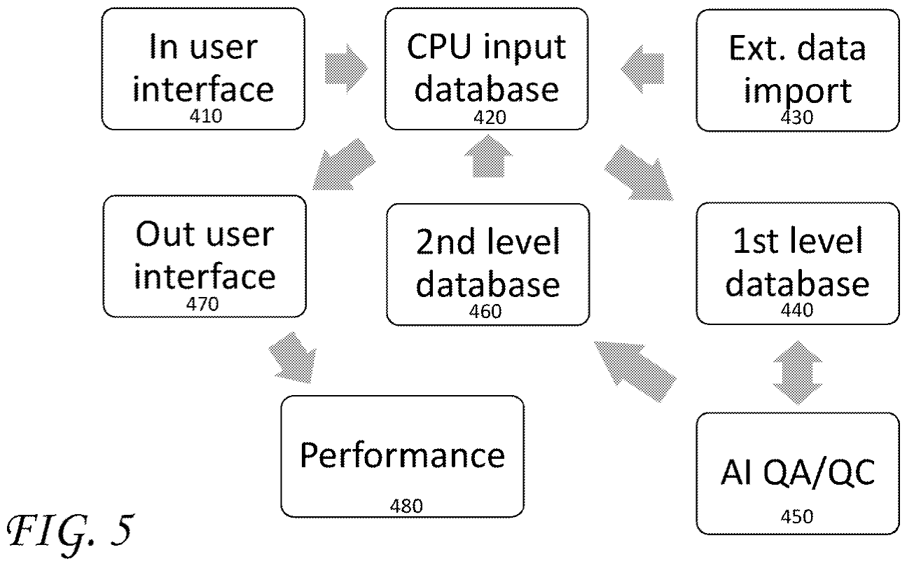

FIG. 5 is a flow chart depicting interrelated method steps and elements of an embodiment

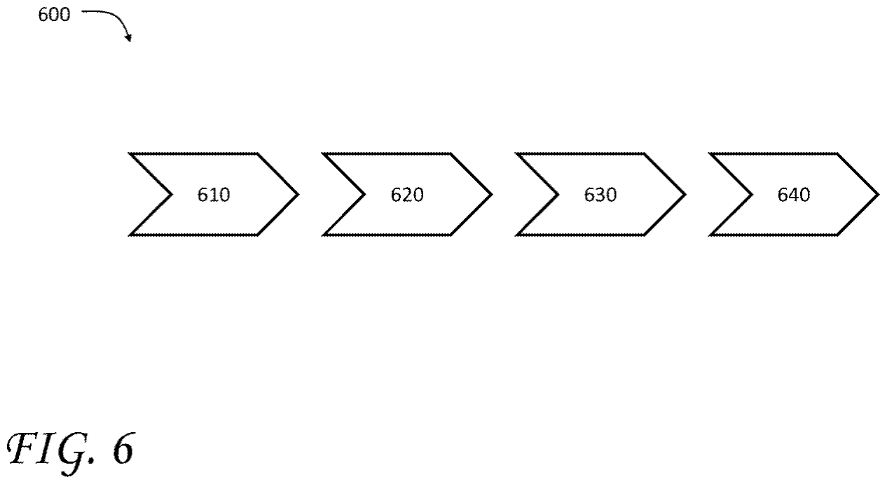

FIG. 6 is a flow chart depicting sequential method steps of an embodiment.

Exhibit A includes information relevant to the present disclosure.

Exhibit B includes information relevant to various workflows of the present disclosure.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Disclosed is a subscription based, integrated and interactive performing arts management platform system and method.

According to a particular embodiment, the performing arts management system (and its concomitant method) (also referred to herein as “PAMS”) is an intuitive dashboard driven system drawing on multiple layers of integrated industry data which is constantly updated with real-time user data from its subscribers. This transformational software redefines and essentially democratizes the live performance industry by connecting performers, managers, venue operators, ticket sellers and buyers, VIP activities, merchandise and other functions on a common fully integrated electronic platform.

In some embodiments, the PAMS offers a unified platform on which to manage every aspect of the performing arts business. It integrates multiple data bases, real time algorithms, expressed user preferences, historic data, financial forecasting, logistics, routing, secure financial transactions, ticket sales, as well as merchandise and other licensed products into a single integrated platform across multiple company boundaries.

In some embodiments, the PAMS system provides a transparent and integrated platform on which the artist (and/or their management) can plan and manage all business activities allowing tours and performances to be scheduled based on the artist's unique priorities including detailed venue selection criteria, revenue optimization, demographics, ticket pricing, merchandise sales, food and beverage sales, drive or flight time, start and end locations, venue availability etc., while simultaneously providing the venue operators with data needed to evaluate viability of the artist in their market and, if they choose, schedule the artists performance, evaluate technical riders, enter into contracts, and make financial transactions from initial guarantee and deposits to post show settlements.

In some embodiments, the PAMS system connects the artist with every aspect of the performance business. It allows the artist to completely control and plan performing arts tours with maximized routing based on a customized matrix of data selected by the artist which achieves the artist's goals and objectives.

From the venue perspective, some embodiments of the PAMS system enables the venue operator to display available dates, seating capacity, costs, and a matrix of performance related information so that the artists and venue can easily enter into a transaction for performance dates (from on-off fillers to full tours), thereby creating a dynamic and liquid market place in which the performer and the venues can efficiently interact and conduct business directly. Thus, the PAMS system offers the venue operator integrated capabilities which deliver tangible benefits, market insights and advanced analytics to enhance revenue management and fan experience.

From the ticket buyer perspective (i.e., the customer), some embodiments of the PAMS system offer maximum opportunity to the customer to obtain premium features, integrated packages (VIP, food and beverage, “meet and greets,” combined lodging travel and meals, and the like), and the opportunity to interact directly with the venue and the artist via all common social media platforms. These direct communication channels also provide the perspective ticket buyer with the opportunity to obtain early notification and other resources commensurate with the ticket buyers' participation level.

In some embodiments, the PAMS system engages multiple perspectives and multiple categories of users. Here, PAMS user experiences are defined from each users' point of view: artist, venue, and performance attendee (customer). To address each of these varying needs, the PAMS system has been developed to interact in a seamless and transparent way, thereby allowing operation from the varying perspectives of the user rather than a single top down model.

Here also, the PAMS system users are at the center of the business transformation, and business operations are coupled to have a PAMS system user focus. In other words, the PAMS system (and its method of use) addresses processes, technology, and business focus in integrated and targeted channels to fit the needs of the PAMS system user from that unique user perspective.

Here also, the PAMS system enables unbroken collaboration across multiple organizations. It is well known in the performance management arts that older technology silos limit information sharing and collaboration. Thus, in one embodiment, the PAMS system enables all users, from their unique user perspective, to work across organization structures and functions to meet the needs unique to each individual user.

Here also, the PAMS system provides holistic end to end functionality. For example, in some embodiments, the PAMS system (1) maps user paths and experiences, and (2) integrates every business aspect of the performance industry fundamentally and comprehensively transforming the experience of all users across the performing arts industry.

Turing to FIG. 1, in one embodiment, the invention provides a system 100 for managing performing arts. Here, a user 110 communicates by way of a user interface 120 with a computer running software 130 that accesses, organizes, and presents data housed in a database 140. In some embodiments, the user 110 provides data (i.e., user input information) to the database 140. In some embodiments, the user 110 and third party databases 150 provide data (i.e., user input information) to the database 140.

In some embodiments, the user 110 is any one of a performing arts customer, a performer, a venue operator, a manager, and/or a ticket re-seller.

In some embodiments, the user interface 120 includes any one or more of (1) a device with a visual screen and optionally an audio system comprising a microphone and speaker, such as a mobile phone, a smart phone, a laptop, a server, a computer, a tablet, or the like, (2) a graphic display for presenting text, images, and numeric data to a user, (3) a means for inputting data, and/or (4) hypermedia software.

In some embodiments, the user interface 120 displays information such as (1) logistical information including drive or flight time, start and end locations, detailed venue information, scheduling information, and contract information; (2) financial information including fund routing information, contract terms information, deposit information, guarantee information, and post-show settlement information; (3) user preferences; and (4) the like.

In some embodiments, the computer running software 130 includes a data collection robot, software algorithms and programs, and a database engine.

In some embodiments, the database engine includes data mining tools that employ artificial intelligence, and a user interface that employs hypermedia in a form that uniformly manages text, images, and numeric data, wherein the database engine merges relational database techniques with object orientation.

In some embodiments, the software algorithm or program includes (1) one or more algorithms that interact with the database, other applications, and the user interface, (2) a data definition language (DDL), (3) a data manipulation language (DML), and a structured query language (SQL). Here, the program (1) captures and analyzes data, said data comprising user input data and database data, (2) combines the DDL and the DML into SQL declarative language, and (3) houses the data collection robot.

In some embodiments, the database 140 includes data resources such as, e.g., ticket purchase information, such as, e.g., price, date, venue, performer, and purchaser personal information; venue information such as, e.g., location, capacity, performance attendance, ticket sales, food and beverage sales, pre-sales, VIP upgrades, meet and greet sales, and merchandise sales; consumed media information such as, e.g., information obtained from one or more music streaming services; social media information, such as, e.g., information obtained from one or more social media services government data, such as, e.g., information obtained from one or more of U.S. Bureau of the Census, U.S. Bureau of Labor Statistics, FedStats, current population statistics, and city and county business patterns; and market radio (or other) data.

Here, the consumed media information, social media information, government data, and market radio data is obtained from a third party database 150 in communication with the computer running software 130.

In some embodiments, the database 140 is an intelligent database the includes a relational database, has a sequential format and a non-sequential format, contains data from both public and proprietary resources, and includes structured data in tables and records.

Turning to FIG. 2, in some embodiments, the invention provides a system 200 for managing performing arts, including multiple user/interfaces 210-250 and an intelligent database 260. Here, each user connects to the common intelligent database 260 through an interface and accesses the content of the intelligent database to coordinate activities such as ticket purchase, venue securement, contracting, payments, and the like as those activities relate to performing arts performances and communicate in a democratic/silo free manner to facilitate the performing arts activities.

In some embodiments, a customer (ticket purchaser)/customer interface 210, a performer/performer interface 220, venue operator/venue operator interface 230, performer's manager or agent/agent interface 240, and ticket jobber/ticket jobber interface 250 communicate with the intelligent database 260 to exchange information related to ticket purchasing, venue arrangement, payment, and other contract management activities to facilitate initiating, managing, administering, and executing a performance at a venue.

In some embodiments, the exchanged information includes ticket purchase information (price, date, venue, performer, and purchaser personal information), venue information (location, capacity, performance attendance, ticket sales, food and beverage sales, pre-sales, VIP upgrades, meet and greet sales, and merchandise sales), consumed media information obtained from one or more music streaming services, social media information, government demographic data, and user interface information, including logistical information (drive or flight time, start and end locations, detailed venue information, scheduling information, and contract information), financial information (fund routing information, contract information, deposit information, guarantee information, and post-show settlement information), and user preferences.

In some embodiments, the intelligent database 260 includes a database management system and data resources. In one embodiment, the database management system includes a database, a database engine, software (programs and algorithms), and an AI-enabled data collection robot.

Turning to FIG. 3, in one embodiment, the invention provides a performing arts management system 300 that includes multiple users 305-330 and multiple third party data sources 360-375 that input data into and receive data from an intelligent database 350. Here, each user connects to the common intelligent database 350 through an interface and accesses the content of the intelligent database to coordinate activities such as ticket purchase, venue securement, contracting, payments, and the like as those activities relate to performing arts performances and communicate in a democratic/silo free manner to facilitate the performing arts activities. Here also, each third party data source 360-375 shares information with the intelligent database 350 and the users 305-330 via the intelligent database 350.

In some embodiments, a customer (ticket purchaser) 305, a performer 310, a venue operator 315, and optionally a performer's manager 320, and third party ticket seller (i.e., jobber) 330 communicate with the intelligent database 350 and concomitantly with the third party data sources 360-375 to exchange information related to ticket purchasing, venue arrangement, payment, and other contract management activities to facilitate initiating, managing, administering, and executing a performance at a venue.

In some embodiments, the intelligent database 350 includes a database management system and data resources. In one embodiment, the database management system includes a database, a database engine, software (programs and algorithms), and an AI-enabled data collection robot.

In some embodiments, the third party data sources include consumed media information 360, social media information 365, government data 370, and market radio data 375. Here, the consumed media information 360 contains information obtained from one or more music streaming services, the social media information 365 contains information obtained from one or more social media services, and the government data 370 contains information obtained from one or more of U.S. Bureau of the Census, U.S. Bureau of Labor Statistics, FedStats, current population statistics, and city and county business patterns.

Turning to FIG. 4, in one embodiment, the invention provides a performing arts management system 400 that includes multiple users 405, 410, 415, 420, 425, multiple user interfaces 406, 411, 416, 421, 426, multiple third party data sources 430, 435, 440, 445, data and data resources 460, and a database management system 450. Here, each user interacts through their respective interface with the communal intelligent database system 450 and 460 and the other users and third party data sources 430-445 to facilitate the management of performing arts at any given venue. Here also, the system 400 employs the database management system 450 to collect and process customer data, create predictive models of a performer, a venue, and/or audience behavior, and create accurate detailed models to predict sales, optimal scheduling, venue selection, ticket and product pricing by applying relational aspects of artist, venue, and customer to the data sources.

In one embodiment, the database management system 450 contains an intelligent database manager, a database engine, a software program, and/or a data collection robot.

In one embodiment, each user interface 406, 411, 416, 421, 426 includes a device with a visual screen and optionally an audio system comprising a microphone and speaker, a graphic display for presenting text, images, and numeric data to a user, a means for inputting data, and hypermedia software.

In one embodiment, the data or data resources include ticket purchase information, venue information, consumed media information, social media information, government data, and/or market radio data.

In one embodiment, the venue is any one of a virtual performance venue (on-line or streaming), a concert hall, a civic center, a stadium, a theater, and an amphitheater, or the like.

In one embodiment, the database portion of the database management system 450 is an intelligent database that includes a relational database, a sequential format, a non-sequential format, data from public and proprietary resources, and/or structured data in tables and records.

In one embodiment, the database management system 450 contains a database engine containing (1) high level data mining tools that employ artificial intelligence, which manage data quality and discover relevant patterns in the data with a process called data mining and often relies on the use of techniques, and (2) a user interface that employs hypermedia in a form that uniformly manages text, images, and numeric data, such that the database engine that supports smart data mining and hypermedia user interface and merges relational database techniques with object orientation.

In one embodiment, the database management system 450 contains a software program with (1) one or more algorithms that interact with the database, other applications, and the user interface 406, 411, 416, 421, 426, (2) a data definition language (DDL), (3) a data manipulation language (DML), and (4) a structured query language (SQL). In one embodiment, the software program (1) captures and analyzes data containing user input data and database data, (2) combines the DDL and the DML into SQL declarative language, and (3) houses a data collection robot.

In one embodiment, the data collection robot (1) employs artificial intelligence to collect data and create intelligent data, (2) employs high level tools to manage data quality, (3) and employs data mining to discover relevant patterns in the data.

In one embodiment, the data source information 460 contains (1) ticket purchase information including price, date, venue, performer, and purchaser personal information, (2) venue information including location, capacity, performance attendance, ticket sales, food and beverage sales, pre-sales, VIP upgrades, meet and greet sales, and merchandise sales, (3) consumed media information including information obtained from one or more music streaming services 430, (4) social media information including information obtained from one or more social media services 435, (5) government data including information obtained from one or more of U.S. Bureau of the Census, U.S. Bureau of Labor Statistics, FedStats, current population statistics, and city and county business patterns available form public government databases 440, and (6) radio media marketing and demographic data from radio marketing sources 445.

In one embodiment, the system 400 is a subscription-based system adapted for use by a subscriber, wherein the subscriber is a user 405, 410, 415, 420, 425 of the system 400. In a specific embodiment, the system 400 coordinates multiple categories of users. Here, the users include a customer 405, a performer 410, a ticket seller 415, a manager 420, a venue operator 425, a variable workforce worker for show execution, and optionally an advertiser.

In one embodiment, the user interface 406, 411, 416, 421, 426 displays information that contains logistical information including drive or flight time, start and end locations, detailed venue information, scheduling information, and contract information, financial information including fund routing information, contract information, deposit information, guarantee information, and post-show settlement information, and user preferences.

In one embodiment, the system 400 enables the performer 410 to connect to other subscribers 405, 415, 420, 425 and the database 460, and to control the process of engaging customers 405 or venue operators 425. Additionally, the system 400 enables the venue operator 425 to connect to other subscribers 405, 410, 415, 420 and the database 460, and to control the process of engaging customers 405 or performers 410. Additionally, the system 400 enables the customer 405 to connect to other subscribers 410, 415, 420, 425 and the database 460, and to control the process of engaging venues 425 or performers 410.

In one embodiment, the system 400 provides a performing arts customer 405 with up-to-date information on performance venues 425, performers 410 and ticket prices and availability, premium features and integrated packages related to performers or performances, social media content related to performers, performances and venues, and early notification related to performance opportunities or changes associated with a performance, performer or venue.

In one embodiment, the system 400 provides a performer 410 with up-to-date information on performance venues 425, customers 405, ticket prices and availability, available dates and seating capacity and format for any given venue, the ability to create and define premium features and integrated packages, social media content related to performers, performances and venues, and early notification related to performance opportunities or changes associated with a performance, performer or venue.

Turning to FIG. 5, in one embodiment, the invention provides a method 500 for coordinating and managing performing arts activities. Here, a user utilizes their user interface to input information 410, which is processed by a central processing unit (CPU) 420 and exported into a first level database 440. Additionally, external data 430 is processed by the CPU 420 and exported into a first level database 440. The first level data in the first level database is generally relatively unorganized and is processed by an artificial intelligence enabled robot that performs quality control, data mining, and data organization 450 to create an intelligent second level database 460 that is accessed by the user through their interface 470 via the CPU 420 to schedule, manage, contract, and/or pay for a performance at a venue 480. Here, the users include the customer, the performer, the venue operator, and optionally a manager, a third party ticket seller, and an advertiser.

Turning to FIG. 6, in a specific embodiment, the invention provides a method 600 for coordinating and managing performing arts activities. Here, a performer (artist) 610 inputs into or accesses from a database management system information regarding their availability dates, ticket price range, commercial terms, desired venue location and attribute, demographics and venues of prior shows, and acceptance of show offer. The venue 620 inputs into or accesses from the database management system information regarding open dates, data from artist previous shows, ticket price and room scaling, feedback from sponsoring patrons, and bid offering for show. Promotion of the show 630 includes providing to a user interface from the database management system automatic notification of show via text, email, or social media, preferred ticket sales structure, when ticket sales immediately available and the priority of the availability based on participation levels of patronship, advanced merchandise purchase options, and upgrade, food and beverages packages, and artist “meet and greet” options. Operation or execution of the show 640 enables venue control of notification and engagement of a variable workforce, auto-notification to the variable workforce, automated acceptance to work a show, report times, automated timesheets and human resources tools, and food and beverage ordering tools.

In some embodiments, the system and method provide for the generation of a customer persona. In some embodiments, the customer persona is a archetype that is assigned to a user or audience based on one or more of the information and/or data available or generated by the system, such as the aforementioned data in this disclosure and/or the data types mentioned in Exhibit A. In some embodiments, the customer persona represents the key traits of a large segment of the customers or audience. In some embodiments, customer personas provide insight as to the user's interactions and incentives when considering their customers and/or audience. Examples of such personas are provided in Exhibit A.

Still referring to Exhibit A, one or more experience flow is provided. In some embodiments, the experience flow is a workflow, such as a set of steps or logical chain for progressing through one or more task associated with the system. Experience flows include, but are not limited to: Buyer onboarding, Seller onboarding, Seller platform experience, and Buyer platform experience. Detailed flowcharts for at least some of the workflows are provided for in Exhibit B.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A performing arts management system comprising:
a user interface;
a database management system;
data resources; and
a venue.

2. The system of claim 1, wherein the database management system comprises:
a database;
a database engine;
a program; and
a data collection robot;

3. The system of claim 2, wherein the user interface comprises:
a device with a visual screen and optionally an audio system comprising a microphone and speaker;
a graphic display for presenting text, images, and numeric data to a user;
a means for inputting data; and
hypermedia software.

4. The system of claim 3, wherein the data resources comprise one or more of:
ticket purchase information;
venue information;
consumed media information;
social media information;
government data; and
market radio data.

5. The system of claim 4, wherein the venue comprises any one or more of:
virtual performance venue;
concert hall;
civic center;
stadium;
theater; and
amphitheater.

6. The system of claim 5, wherein the database is an intelligent database comprising:
a relational database;
a sequential format;
a non-sequential format;
data from public and proprietary resources; and
structured data in tables and records.

7. The system of claim 6, wherein the database engine comprises two layers with high level tools and user interfaces and said database engine merges relational database techniques with object orientation.

8. The system of claim 7, wherein the program comprises:
one or more algorithms that interact with the database, other applications, and the user interface;
a data definition language (DDL);
a data manipulation language (DML); and
a structured query language (SQL),
wherein said program (i) captures and analyzes data, said data comprising user input data and database data, (ii) combines the DDL and the DML into SQL declarative language, and (iii) houses the data collection robot.

9. The system of claim 8, wherein the data collection robot (i) employs artificial intelligence to collect data and create intelligent data, (ii) employs high level tools to manage data quality, (iii) and employs data mining to discover relevant patterns in the data.

10. The system of claim 9, wherein the ticket purchase information comprises price, date, venue, performer, and purchaser personal information.

11. The system of claim 10, wherein the venue information comprises location, capacity, performance attendance, ticket sales, food and beverage sales, pre-sales, VIP upgrades, meet and greet sales, and merchandise sales.

12. The system of claim 11, wherein the consumed media information comprises information obtained from one or more music streaming services and the social media information comprises information obtained from one or more social media services.

13. The system of claim 12, wherein the government data comprises information obtained from one or more of U.S. Bureau of the Census, U.S. Bureau of Labor Statistics, FedStats, current population statistics, and city and county business patterns.

14. The system of claim 13, wherein the user interface displays information comprising:
logistical information including drive or flight time, start and end locations, detailed venue information, scheduling information, and contract information;
financial information including fund routing information, contract information, deposit information; guarantee information, and post-show settlement information; and
user preferences.

15. The system of claim 14, wherein said system is a subscription-based system adapted for use by a subscriber selected from the group consisting of a customer, a performer, a ticket seller, a manager, a venue operator, and an advertiser.

16. The system of claim 15, wherein the subscriber is a user of the system.

17. The system of claim 16, wherein the system enables the performer to connect to other subscribers and the database, and to control the process of engaging customers or venues.

18. The system of claim 17, wherein the system enables the venue operator to connect to other subscribers and the database, and to control the process of engaging customers or performers.

19. The system of claim 18, wherein the system enables the customer to connect to other subscribers and the database, and to control the process of engaging venues or performers.

20. The system of claim 19, wherein the system provides a performing arts customer with up-to-date information on performance venues, performers and ticket prices and availability, premium features and integrated packages related to performers or performances, social media content related to performers, performances and venues, and early notification related to performance opportunities or changes associated with a performance, performer or venue.
